(19) United States
(12) Patent Application Publication
(10) Pub. No.: US 2008/0078362 A1
(43) Pub. Date: Apr. 3, 2008

(54) Variable discharge pump having single control valve

(75) Inventor: Ye Tian, Bloomington, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/529,266

(22) Filed: Sep. 29, 2006

(51) Int. Cl. F02M 57/02; F02M 37/04

(52) U.S. Cl. 123/446; 123/506

(57) ABSTRACT

A pumping arrangement for an internal combustion engine is disclosed. The pumping arrangement may have a first pumping chamber, a second pumping chamber, a first plunger, and a second plunger. The first and second plungers may be movable within the first and second pumping chambers between first and second spaced apart end positions to pressurize a fluid. The second plunger may move out of phase relative to the first plunger. The pumping arrangement may also have a single electronically controlled valve configured to meter the amount of fluid spilled from each of the first and second plungers.

### TECHNICAL FIELD

The present disclosure relates generally to a variable discharge pump and, more particularly, to a variable discharge pump having a single control valve common to multiple plungers.

### BACKGROUND

Common rail fuel systems typically employ multiple injectors connected to a common rail that is provided with high pressure fuel. In order to efficiently accommodate the different combinations of injections at a variety of timings and injection amounts, the systems generally include a variable discharge pump in fluid communication with the common rail. One type of variable discharge pump is the cam driven, inlet or outlet metered pump.

A cam driven, inlet or outlet metered pump generally includes multiple plungers, each plunger being disposed within an individual pumping chamber. The plunger is connected to a lobed cam by way of a follower, such that, as the cam rotates, the lobe(s) reciprocatingly drives the plunger to displace fuel from the pumping chamber into the common rail. The amount of fuel pumped by the plunger into the common rail depends on the amount of fuel metered into the pumping chamber prior to the displacing movement of the plunger, or the amount of fluid spilled (i.e., metered) to a low pressure reservoir during the displacing stroke of the plunger.

Control over the amount of fuel metered into the pumping chamber or spilled to the low pressure reservoir is typically provided by a separate solenoid valve associated with each plunger. That is, when the different plungers are driven out of phase relative to each other, each plunger's dedicated solenoid valve functions to selectively open and allow fuel to fill the pumping chamber during a portion of an intake stroke and close during the displacement stroke, or open during the intake stroke and selectively close during a portion of the displacement stroke. Although this arrangement may effectively provide the demanded variable flow rate of high pressure fuel, the number of different solenoid valves increases the control complexity and cost of the fuel system.

One attempt to reduce the control complexity and cost of a common rail fuel system is described in U.S. Pat. No. 5,404,855 (the '855 patent) to Yen et al. on Apr. 11, 1995. Specifically, the '855 patent teaches a variable discharge high pressure pump having a plurality of high pressure pumping units, which receive fuel from a low pressure fuel pump. A rotary cam driven roller tappet is connected to a plunger of each pumping unit by a separated link in a manner permitting the plunger to float relative to the roller tappet during at least a portion of each pumping cycle. A variably restricted orifice is provided at an inlet common to all of the pumping units.

As the cam of the '855 patent rotates, the tappet follows the cam profile and moves downward through an intake stroke. During this downward movement of the tappet, the associated plunger separates from the tappet and only moves downward an amount corresponding to the fuel flowing into each pumping unit. Then, as the cam continues to rotate, the tappet is driven upward and into contact with the plunger, at which time fuel displacement from the pumping unit begins. By varying the restriction at the common inlet, the amount of fuel flowing into each pumping unit during the downward stroke of the plunger and subsequently discharged during the upward stroke of the plunger can be regulated. Because regulation of fuel displacement from all of the pumping units of the '855 patent is accomplished with a single control valve (i.e., the variable restricted orifice at the common inlet), control complexity and cost of the variable discharge pump is reduced as compared to previous pump designs.

While the discharge pump of the '855 patent may effectively provide variable flow at reduced complexity and cost, it may be problematic. Specifically, because the plunger of each pumping unit is allowed to separate from its associated tappet during the downward intake stroke, the re-engagement of the pumping unit and tappet during the upward pumping stroke may be damaging to the plunger and/or tappet. That is, continued collision between the plunger and tappet over a period of time could result in erosion of the engaging surfaces. In addition, because the inlet flow of the pumping unit is metered during the downward stroke of the plunger, it may be possible for the pumping unit to cavitate. In other words, during the downward stroke of the plunger, the low pressure within the pumping unit may draw air bubbles out of the fuel therein and, during the ensuing upward stroke of the plunger, the air bubbles may violently collapse, causing erosion of the pumping unit.

The disclosed variable discharge pump is directed to overcoming one or more of the problems set forth above.

### SUMMARY OF THE INVENTION

In one aspect, the present disclosure is directed to a pumping arrangement that may include a first pumping chamber, a second pumping chamber, a first plunger, and a second plunger. The first and second plungers may be movable within the first and second pumping chambers between first and second spaced apart end positions to pressurize a fluid. The second plunger may move out of phase relative to the first plunger. The pumping arrangement may also include a single electronically controlled valve configured to meter the amount of fluid spilled from each of the first and second plungers.

In another aspect, the present disclosure is directed to a method of pressurizing fluid. The method may include pressurizing a fluid to a first level, directing the pressurized fluid to a first pumping device, and directing low pressure fluid to a second pumping device. The method may also include selectively restricting a flow of the pressurized fluid to spill fluid from the first pumping device and the second pumping device.

### BRIEF DESCRIPTION OF THE DRAWINGS

FIG. 1 is a diagrammatic illustration of an exemplary disclosed common rail fuel system; and

FIG. 2 is an enlarged diagrammatic illustration of a portion of the common rail fuel system of FIG. 1.

### DETAILED DESCRIPTION

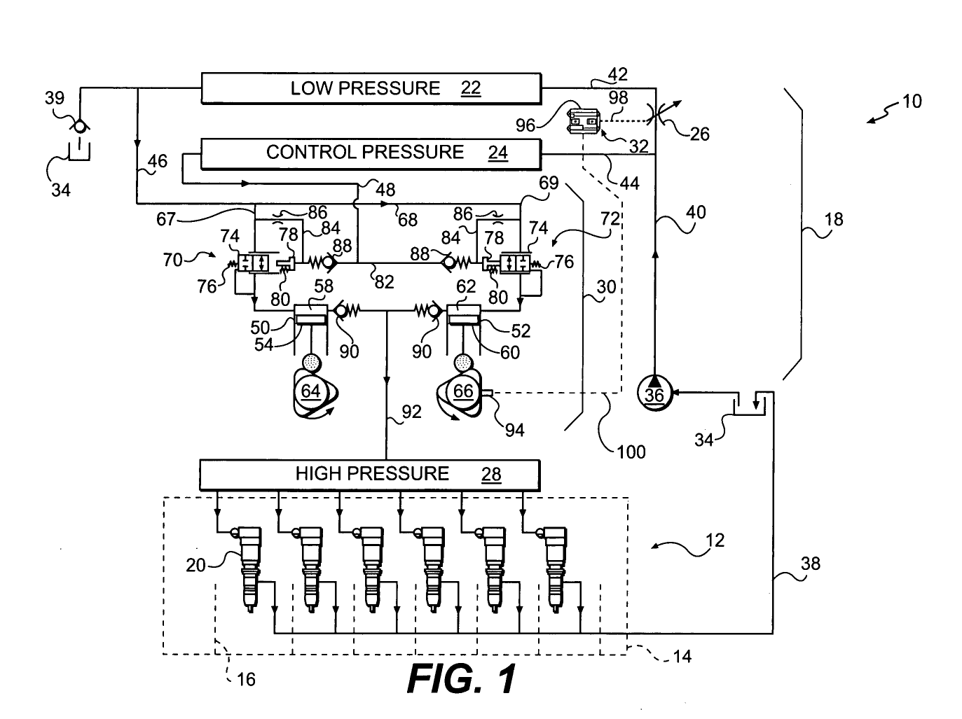

An exemplary embodiment of a power system 10 is illustrated in FIG. 1. Power system 10 may include an internal combustion engine 12 that, for the purposes of this disclosure, is depicted and described as a four-stroke diesel engine. One skilled in the art will recognize, however, that engine 12 may be any other type of internal combustion engine such as, for example, a gasoline or gaseous fuel powered engine.

As illustrated in FIG. 1, engine 12 includes an engine block 14 that defines a plurality of cylinders (not shown). A piston (not shown) is slidably disposed within each cylinder. Engine 12 may also include a cylinder head (not shown) associated with each cylinder. The cylinder, piston, and cylinder head may form a combustion chamber 16. In the illustrated embodiment, engine 12 includes six combustion chambers 16. One skilled in the art will readily recognize, however, that engine 12 may include a greater or lesser number of combustion chambers 16 and that combustion chambers 16 may be disposed in an “in-line” configuration, a “V” configuration, or any other conventional configuration.

As also shown in FIG. 1, power system 10 may also include a fuel system 18 having a series of fuel injectors 20, a low pressure manifold 22, a control pressure manifold 24, a single electronic control valve 26, a high pressure manifold 28, a high pressure pump 30, and a control system 32. Fuel may be drawn from a low pressure reservoir 34 by a transfer pump 36 and directed through low pressure manifold 22 to high pressure pump 30 where the pressure of the fuel is increased. From high pressure pump 30, the high pressure fuel may then be directed through high pressure manifold 28 to fuel injectors 20. Each fuel injector 20 may be operable to inject an amount of the pressurized fuel into combustion chamber 16 at predetermined timings, fuel pressures, and fuel flow rates. Fuel injectors 20 may be fluidly connected to return unused fuel to low pressure reservoir 34 via a leak return path 38.

Low and control pressure manifolds 22, 24 may be connected to receive low pressure fuel in parallel. Specifically, low and control pressure manifolds 22, 24 may be connected to transfer pump 36 via a common upstream passageway 40, and individual branch passageways 42 and 44, respectively. The fuel from low pressure manifold 22 may flow to high pressure pump 30 via a supply passageway 46. The fuel from control pressure manifold 24 may flow to high pressure pump 30 via a control passageway 48. A pressure control check valve 39 may be associated with low pressure manifold 22 to regulate the pressure therein.

Electronic control valve 26 may be disposed within branch passageway 42 to regulate the pressure of the fuel within control pressure manifold 24. Electronic control valve 26 may include, for example, a proportional valve element, a variable restrictive orifice, or other suitable device movable by an electronic actuator to selectively restrict the flow of fuel to low pressure manifold 22. The amount of restriction may be dependent on the current applied to the actuator. As the fuel flow to low pressure manifold 22 is restricted, the amount of fuel flowing to, and, subsequently, the pressure of the fuel within control pressure manifold 24 may increase proportionally.

High-pressure pump 30 may include a housing defining a first barrel 50 and a second barrel 52. High-pressure pump 30 may also include a first plunger 54 slidably disposed within first barrel 50 and, together, first barrel 50 and first plunger 54 may define a first pumping chamber 58. High-pressure pump 30 may further include a second plunger 60 slidably disposed within second barrel 52 and, together, second barrel 52 and second plunger 60 may define a second pumping chamber 62.

A first and second driver 64, 66 may be operably connected to first and second plungers 54, 60, respectively. High pressure pump 30 may include any means for driving first and second plungers 54, 60 such as, for example, a cam, a solenoid actuator, a piezo actuator, a hydraulic actuator, a motor, or any other driving means known in the art. A rotation of first driver 64 may result in a corresponding reciprocation of first plunger 54 within first barrel 50, and a rotation of second driver 66 may result in a corresponding reciprocation of second plunger 60 within second barrel 52. First and second drivers 64, 66 may be positioned relative to each other such that first and second plungers 54, 60 are caused to reciprocate out of phase with one another. First and second drivers 64, 66 may each include three lobes such that one rotation of a pump shaft (not shown) connected to first and second drivers 64, 66 may result in six pumping strokes. Alternately, first and second drivers 64, 66 may include a different number of lobes rotated at a rate such that pumping activity is synchronized to fuel injection activity.

High-pressure pump 30 may include a low pressure gallery 68 in fluid communication with low pressure manifold 22 via supply passageway 46 and in selective communication with first and second pumping chambers 58, 62 via branch passageways 67 and 69, respectively. A first inlet valve 70 may be disposed within branch passageway 67, between low pressure gallery 68 and first pumping chamber 58, and may selectively allow a flow of low pressure fuel from low pressure gallery 68 to first pumping chamber 58 and, in reverse direction, from first pumping chamber 58 to low pressure gallery 68. A second inlet valve 72 may be disposed within branch passageway 69, between low pressure gallery 68 and second pumping chamber 62, and may allow a flow of low pressure fuel from low pressure gallery 68 to second pumping chamber 62 and, in reverse direction, from second pumping chamber 62 to low pressure gallery 68.

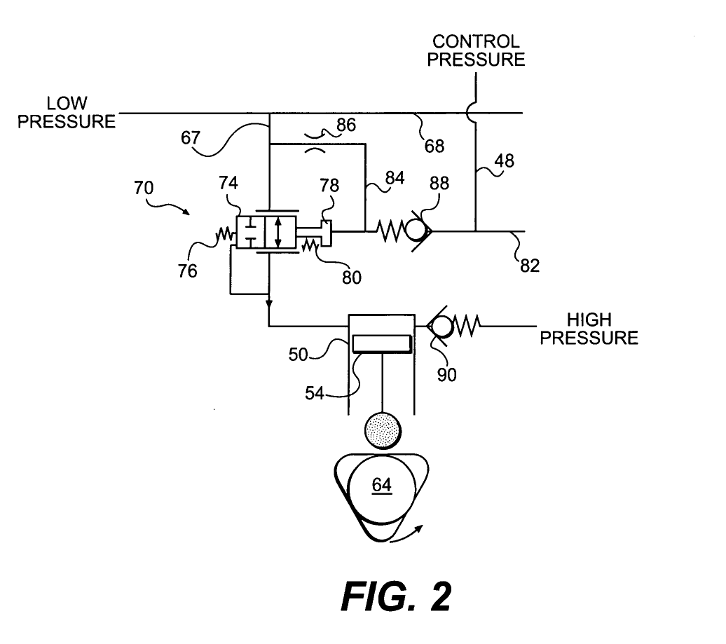

Each inlet valve 70, 72 may include a proportional valve element 74. Valve element 74 may be movable between a first position at which fluid communication between low pressure manifold 22 and first or second pumping chamber 58 or 62 is allowed, and a second position at which the communication is blocked. Valve element 74 may be movable to any position between the first and second positions to vary a flow rate of fuel therethrough. FIG. 1 illustrates valve element 74 of first inlet valve 70 being in the first or flow passing position. In contrast, valve element 74 of second inlet valve 72 is illustrated as being in the second or flow blocking position. FIG. 2 illustrates valve element 74 at a location substantially midway between the first and second positions to allow a reduced a flow of fuel therethrough.

Valve element 74 may be spring biased and pilot actuated. That is, a return spring 76 may bias valve element 74 toward the second position (i.e., the position illustrated in FIG. 2), and valve element 74 may be movable against the spring bias toward the first position in response to a pressure of fuel acting on an end(s) of valve element 74. For example, when the pressure of the fuel within the associated pumping chamber drops below a predetermined threshold, valve element 74 may be drawn against the spring bias toward the first position. In contrast, as the pressure of the fuel within the pumping chamber exceeds the threshold, valve element 74 may be returned by spring 76 and the fuel pressure within the pumping chamber toward the second position.

During its movement toward the second position, valve element 74 may be blocked in a partially open position to control the spill rate of fuel from the associated pumping chamber. In particular, high pressure pump 30 may include a control piston 78 movable from a first or disengaged position at which control piston 78 has substantially no effect on valve element 74, to a second or fully engaged position at which control piston 78 is blocking valve element 74 in a maximum flow passing position. Control piston 78 may be movable to any location between the first and second positions to vary the open amount of valve element 74 and the subsequent spill rate of fuel therethrough.

Control piston 78 may also be spring biased and pilot operated. That is, a return spring 80 may bias control piston 78 away from engagement with valve element 74 and toward the first position, and control piston 78 may be movable against the spring bias toward the second position in response to a pressure of fuel within control pressure manifold 24. For example, an end of control piston 78 may be fluidly communicated with control passageway 48 by way of a control gallery 82. When the force generated by the pressure of the fuel within control pressure manifold 24 acting on an end of control piston 78 exceeds the bias of return spring 80, control piston 78 may be moved to engage valve element 74. In contrast, when the force generated by the pressure of the fuel within control pressure manifold 24 acting on the end of control piston 78 drops below the bias of return spring 80, control piston 78 may be returned by spring 80 to its disengaged position.

Control piston 78 may be used to slow the motion of valve element 74. That is, even when the pressure of the fuel acting on the end of control piston 78 is great enough to engage control piston 78 with valve element 74, it may be insufficient to overcome the biasing force of return spring 76 combined with the force generated by the pressure of the associated pumping chamber acting on the end of valve element 74. In this situation, control piston 78 may be forced back toward its first position, and the fuel acting on the end of control piston 78 may be forced into low pressure gallery 68 by way of a bypass passageway 84. A restricted orifice 86 may be provided within bypass passageway 84 to control the flow rate of fuel into low pressure gallery 68 and, subsequently, the returning speed of control piston 78 and engaged valve element 74. A check valve 88 associated with each control piston 78 may ensure that this fuel displacing from the end of control piston 78 flows through bypass passageway 84 instead of back into control gallery 82.

The movement of valve element 74 may effect the amount of fuel displaced from the associated pumping chamber. With reference to first pumping chamber 58 of FIG. 1, as first plunger 54 moves through a downward intake stroke following the profile of first driver 64, the pressure within first pumping chamber 58 may reduce sufficiently to draw valve element 74 toward its flow passing position, thereby allowing fuel from low pressure manifold 22 to enter first pumping chamber 58. As first plunger 54 moves through an ensuing upward pumping stroke, the building pressure within first pumping chamber 58 may eventually urge valve element 74 toward its flow blocking position (i.e., the position illustrated in FIG. 1 with respect to second inlet valve 72). Without intervention, valve element 74 may reach its flow blocking position early in the pumping stroke of first plunger 54 and nearly all of the fuel within first pumping chamber 58 may be displaced from first pumping chamber 58 past a check valve 90 to high pressure manifold 28 via a passageway 92. To reduce the amount of fuel displaced to high pressure manifold 28, valve element 74 must remain at least partially open (i.e., in the position illustrated in FIG. 2) for at least a portion of the upward displacing stroke such that some of the fuel displaced from first pumping chamber 58 spills to low pressure gallery 68. Control piston 78 may block valve element 74 in this partially opened position.

The timing at which control piston 78 blocks valve element 74 and to what extent it blocks valve element 74 (i.e., the amount that valve element 74 is blocked open), may be controlled by varying the pressure of the fuel within control pressure manifold 24. For example, by controllably increasing the pressure within control pressure manifold 24 early in the pumping stroke of first plunger 54, valve element 74 may be blocked open for a majority of the pumping stroke and very little fuel may be displaced from first pumping chamber 58 into high pressure manifold 28. In contrast, by increasing the pressure within control pressure manifold 24 late in the pumping stroke of first plunger 54, valve element 74 may be blocked open for only a minor portion of the pumping stroke and the majority of the fuel from within first pumping chamber 58 may be displaced into high pressure manifold 28.

Control system 32 may include multiple components that cooperate to effect the variable restriction of electronic control valve 26. Specifically, control system 32 may a rotational speed sensor 94, and an electronic control module 96 in communication with sensor 94 and control valve 26. Control signals generated by electronic control module 96 and directed to control valve 26 via a communication line 98 may determine when and how much fuel is pumped into high pressure manifold 28. It is contemplated that control system 32 may include additional sensors, if desired, such as a low pressure manifold sensor, a control pressure manifold sensor, a high pressure manifold sensor, or any other type of sensor known in the art.

Rotational speed sensor 94 may embody a magnetic pickup-type sensor. In particular, rotational speed sensor 94 may be associated with first and/or second drivers 64, 66, with a crankshaft of engine 12, or any other rotating pump or drive train component of power system 10 . Rotational speed sensor 94 may sense a rotational speed and produce a corresponding speed signal directed to electronic control module 96 via a communication line 100. For example, rotational speed sensor 94 may include a hall-effect element disposed proximal a magnet (not shown) embedded within a driveshaft of high pressure pump 30 or the crankshaft of engine 12, proximal a magnet (not shown) embedded within a component directly or indirectly driven by the drive or crankshafts, or in other suitable manner to sense a rotational speed of high pressure pump 30 and produce a corresponding speed signal. It is also contemplated that rotational speed sensor 94 could alternatively embody another type of speed sensor such as, for example, a laser sensor, a radar sensor, or other type of speed sensing device, which may or may not be associated with a rotating shaft.

Electronic control module 96 may embody a single microprocessor or multiple microprocessors that include a means for controlling an operation of fuel system 18 in response to the received speed signal. Numerous commercially available microprocessors can be configured to perform the functions of electronic control module 96. It should be appreciated that electronic control module 96 could readily embody a general power system microprocessor capable of controlling numerous power system functions. Electronic control module 96 may include all the components required to run an application such as, for example, a memory, a secondary storage device, and a processor, such as a central processing unit or any other means known in the art for controlling high pressure pump 30. Various other known circuits may be associated with electronic control module 96, including power supply circuitry, signal-conditioning circuitry, solenoid driver circuitry, communication circuitry, and other appropriate circuitry.

One or more maps relating engine or pump speed, desired pump delivery (i.e. the desired amount of fuel displaced by first and second pumping chambers 54, 62 during a single pumping event), and control valve current (i.e., the current applied to electronic control valve 26) may be stored in the memory of electronic control module 96. Each of these maps may be in the form of tables, graphs, and/or equations. In one example, the rotational speed signal generated by sensor 94 and the desired fuel delivery of high pressure pump 30 may form the coordinate axis of a 2-D table. In this same example, the desired fuel delivery and the current supplied to electronic control valve 26 resulting in the desired fuel delivery may form the coordinate axis of another 2-D table. Alternatively, the rotational speed signal may be related directly to control valve current in a single 2-D table, if desired. In this manner, electronic control module 96 may reference the detected rotational speed of high pressure pump 30 with the map or maps stored in the memory thereof, and determine a corresponding current applied to electronic control valve 26 that should result in a desired amount of fuel being delivered to high pressure manifold 28.

### INDUSTRIAL APPLICABILITY

The disclosed pump finds potential application in any fluid system where it is desirous to control a discharge flow rate. The disclosed pump finds particular applicability in fuel injection systems, especially common rail fuel injection systems. One skilled in the art will recognize, however, that the disclosed pump could be utilized in relation to other fluid systems that may or may not be associated with an internal combustion engine. For example, the disclosed pump could be utilized in relation to fluid systems for internal combustion engines that use a hydraulic medium, such as engine lubricating oil. The fluid systems may be used to actuate various sub-systems such as, for example, hydraulically actuated fuel injectors or gas exchange valves used for engine braking. A pump according to the present disclosure could also be substituted for a pair of unit pumps in other fuel systems, including those that do not include a common high pressure manifold.

Referring to FIG. 1, when power system 10 is in operation, first and second drivers 64, 66 may rotate causing first and second plungers 54, 60 to reciprocate within respective first and second barrels 50, 52, out of phase with one another. When first plunger 54 moves through the intake stroke, second plunger 60 may move through the pumping stroke.

During the downward intake stroke of first plunger 54, the resulting low pressure within first pumping chamber 58 may draw fuel into first pumping chamber 58 via first inlet valve 70. Then, as first plunger 54 begins the upward pumping stroke, building fuel pressure within first pumping chamber 58, along with return spring 76, may urge valve element 74 toward a flow blocking position such that pressurized fuel may be displaced from first pumping chamber 58 past check valve 90 into high pressure manifold 28 by way of passageway 92.

To reduce the amount of fuel displaced into high pressure manifold 28, control piston 78 may be moved to engage and block valve element 74. That is, according to a detected rotational speed of high pressure pump 30 and a desired fuel delivery amount, control module 96 may apply a predetermined current to electronic control valve 26, thereby causing electronic control valve 26 to restrict the flow of low pressure fuel from transfer pump 36 to low pressure manifold 22. This restriction may cause an increase in pressure within control pressure manifold 24 that results in the engagement of control piston 78 with valve element 74. Depending on the pressure of the fuel acting on control piston 78, control piston 78 may either slow the return valve element 74 to the flow blocking position or block valve element 74 from return for a predetermined length of time. The amount of upward movement of first plunger 54 that occurs while valve element 74 is in the flow passing position may determine the amount of fuel spilled from first pumping chamber 58 to low pressure manifold 22 and, subsequently, the amount of fuel displaced to high pressure manifold 28 after valve element 74 has moved to the flow blocking position.

One skilled in the art will appreciate that the timing at which electronic control valve 26 is energized, and the extent to which electronic control valve 26 restricts the flow of fuel to low pressure manifold 22 may determine what fraction of the amount of fuel displaced by the first plunger 54 is pumped into the high-pressure manifold 28 and what fraction is spilled back to low pressure manifold 22. This operation may serve as a means by which pressure can be maintained and controlled in high pressure manifold 28. As noted in the previous section, the energizing control of electronic control valve 26 may be provided by signals received from electronic control module 96 over communication line 98.

After first plunger 54 completes the pumping stroke and begins moving in the opposite direction during the intake stroke, the dropping pressure of the fuel within first pumping chamber 58 may create a force that draws valve element 74 back to the flow passing position.

In addition to reduced complexity and cost, several other advantages are realized because high pressure pump 30 utilizes a single electronic control valve to regulate spill from multiple out-of-phase plungers. In particular, because electronic control valve 26 may regulate spill rather than fill of the associated pumping chambers, the likelihood of cavitation therein may be low. In addition and for the same reason, there may be no separation between the plungers of high pressure pump 30 and the drivers. Without separation between these components, the likelihood of damage-causing collisions may be low, if not nonexistent.

It will be apparent to those skilled in the art that various modifications and variations can be made to the pump of the present disclosure. Other embodiments of the pump will be apparent to those skilled in the art from consideration of the specification and practice of the pump disclosed herein. It is intended that the specification and examples be considered as exemplary only, with a true scope being indicated by the following claims and their equivalents.

What is claimed is:

1. A pumping arrangement, comprising:
first pumping chamber;
a second pumping chamber;
a first plunger movable within the first pumping chamber between first and second spaced apart end positions to pressurize a fluid;
a second plunger movable within the second pumping chamber between first and second spaced apart end positions to pressurize a fluid, wherein the second plunger moves out of phase relative to the first plunger; and
a single electronically controlled valve configured to meter the amount of fluid spilled from each of the first and second plungers.

2. The pumping arrangement of claim 1, further including;
a low pressure manifold located upstream of the first and second pumping chambers; and
a high pressure manifold located downstream of the first and second pumping chambers.

3. The pumping arrangement of claim 2, wherein the single control valve is located upstream of the low pressure manifold.

4. The pumping arrangement of claim 3, further including:
an inlet valve movable between a first position at which fluid flows from the low pressure manifold to the first pumping chamber, and a second position at which fluid is blocked from the first pumping chamber; and
a control piston configured to limit the movement of the inlet valve toward the second position.

5. The pumping arrangement of claim 4, wherein a fluid pressure from within the first chamber is communicated with end of the inlet valve; and the inlet valve is movable in response to the communicated fluid pressure.

6. The pumping arrangement of claim 4, wherein the control piston is spring biased away from the inlet valve and the inlet valve is spring biased toward the control piston.

7. The pumping arrangement of claim 4, further including a control pressure manifold located upstream of the first and second pumping chambers.

8. The pumping arrangement of claim 7, wherein the low pressure manifold and the control pressure manifold are disposed in parallel relation.

9. The pumping arrangement of claim 7, wherein the control piston is selectively movable to engage the inlet valve in response to a pressure of fluid in the control pressure manifold.

10. The pumping arrangement of claim 9, wherein the single control valve includes a variable restricted orifice and the restriction of the variable restricted orifice is changed to vary the pressure of the fluid in the control pressure manifold.

11. The pumping arrangement of claim 7, further including a passageway fluidly connecting the control pressure manifold with the low pressure manifold at a location downstream of both the low and control pressure manifolds.

12. The pumping arrangement of claim 11, further including a restricted orifice located within the passageway.

13. A method of pressurizing fluid, comprising:
pressurizing a fluid to a first level;
directing the pressurized fluid to a first pumping device;
directing low pressure fluid to a second pumping device; and
selectively restricting a flow of the pressurized fluid to spill fluid from the first pumping device and the second pumping device.

14. The method of claim 13, wherein the fluid from the first pumping device spills at a first timing and the fluid from the second pumping device spills at a second timing different from the first timing.

15. The method of claim 14, wherein the amount of flow restriction effects at least one of the spill timing and spill amount.

16. The method of claim 13, wherein selectively restricting includes restricting at a location upstream of the first and second pumping devices.

17. The method of claim 13, further including blocking the spilling of fluid to increase the fluid pressure to a second level.

18. The method of claim 17, wherein a timing of the blocking corresponds with an amount of fluid pressurized at the second level.

19. A power system, comprising:
an engine block forming at least one combustion chamber;
a fuel injector configured to inject fuel into the at least one combustion chamber;
a high pressure manifold configured to supply the fuel injector with high pressure fuel;
a transfer pump configured to provide low pressure fuel; and
a pumping arrangement configured to receive the low pressure fuel, increase the pressure of the fuel, and direct high pressure fuel to the high pressure manifold, the pumping arrangement including:
a low pressure manifold in fluid communication with the transfer pump;
a control pressure manifold disposed in series with the low pressure manifold;
a first pumping chamber;
a second pumping chamber;
a first plunger movable within the first pumping chamber between first and second spaced apart end positions to pressurize fuel from the low pressure manifold;
a second plunger movable within the second pumping chamber between first and second spaced apart end positions to pressurize fuel from the low pressure manifold out of phase relative to the first plunger; and
a single electronically controlled valve located upstream of the low pressure manifold and being configured to meter the amount of fuel spilled from each of the first and second plungers.

20. The power system of claim 19, further including:
an inlet valve movable in response to a fuel pressure within the first pumping chamber between a first position at which fuel flows from the low pressure manifold to the first pumping chamber, and a second position at which fuel is blocked from the first pumping chamber; and
a control piston configured to limit the movement of the inlet valve toward the second position,
wherein:
the control piston is spring biased away from the inlet valve;
the control piston is selectively movable to engage the inlet valve in response to a pressure of fuel in the control pressure manifold; and
the inlet valve is spring biased toward the control piston.
